(19) United States
(12) Patent Application Publication
(10) Pub. No.: US 2004/0047105 A1
(43) Pub. Date: Mar. 11, 2004

(54) Protecting device for electrical appliances

(75) Inventors: Michael Bothe, Munster (DE); Ralf Schroder Gen. Berghegger, Glandorf (DE); Hubert Kisfeld, Ostbevern (DE); Michael Feldgen, Ostbevern (DE)

Correspondence Address: MICHAEL BEST & FRIEDRICH, LLP, 100 E WISCONSIN AVENUE, MILWAUKEE, WI, 53202, US

(73) Assignee: FRIWO Geratebau GmbH, Ostbevern (DE)

(21) Appl. No.: 10/612,320

(22) Filed: Jul. 2, 2003

(30) Foreign Application Priority Data
Jul. 2, 2002 (DE) 202 10 213.0

(51) Int. Cl. H01H 47/00

(52) U.S. Cl. 361/139

(57) ABSTRACT

A protecting device for electrical appliances, connected in series with an AC electric circuit of a power supply of the electrical appliance, having an electrically conductive winding, the winding comprising an ohmic resistance for restricting input currents, as well as an interruption function, and a coil form onto which the winding is applied in at least one winding layer, characterized in that the electrically conductive winding is a bifilar winding.

### BACKGROUND OF THE INVENTION

1. Field of the Invention

The present invention relates to a protecting device for electrical appliances and in particular to a protecting device for electrical appliances, connected in series with the AC electric circuit of a power supply of an electrical appliance and comprising an advantageous electromagnetic behaviour due to its design.

2. Description of the Related Art

Failures of electronics, such as household appliances, PCs or appliances in the field of entertainment electronics, caused by transient excess-voltages or retroactions of currents at make, are increasing. Apart from atmospherical discharges, switching procedures in the supply network are also considered to be the main cause for the occurrence of such effects.

In order to meet the requirements of the electromagnetic compatibility (EMC) on electronics, tests and protecting measures are demanded corresponding to the International Electrotechnical Commission (IEC). These tests also include functional demands on the appliances, depending on the load.

In the development of corresponding protecting devices for electrical appliances, the correct choice of the components and their arrangement are critical. Expensive and complex circuits do not necessarily offer a reliable protection.

FIG. 1 shows a schematic representation of usual protecting measures for electrical or electronic appliances. For reducing the inrush currents of an electrical or electronic appliance, a resistance 20 connected in series with a power pack 30 of the appliance is usually used. The ohmic resistance increases the direct impedance of the appliance and thus reduces the maximally possible input current.

In order to restrict an overload current in case of a defect of an electrical or electronic appliance, in addition, a fuse 10 is connected in series with a power supply 30 of the appliance in the switching circuit.

Another possibility of protecting electrical or electronic appliances, in particular in case of electrical appliances with switch-mode power supplies, is the use of a wirewound resistor. In this case, the wire resistor is used, on the one hand, for protecting the appliance from high input currents in case of spikes (surge voltages) and when the power supply is switched on, and on the other hand for opening the circuit in case of an overload current due to an error in the appliance.

The resistors used to this end generally consist of wound resistance wires which cannot be soldered. Another variant for the restriction of the input current is described in the utility model citation DE 20119996U1. In this variant, the input current is restricted by means of a coil with ferrite core and the appliance is protected from an overload current by opening the circuit. Moreover, the coil acts as an inductive component.

The inductive effect of the described components, however, is unfavourable in many applications because of the electromagnetic compatibility.

### SUMMARY OF THE INVENTION

It is the object of the present invention to provide a protecting device for electrical appliances comprising an advantageous electromagnetic behaviour, to be installed into the power supplies of the electrical appliance in a simple and space-saving manner and which is nevertheless inexpensive to manufacture.

This object is achieved by a protecting device for electrical appliances, connected in series with an AC electric circuit of a power supply of the electrical appliance, having an electrically conductive winding, the winding comprising an ohmic resistance for restricting input currents, as well as an opening function, and a coil form onto which the winding is applied in at least one winding layer, characterized in that the electrically conductive winding is a bifilar winding.

Preferred embodiments are the subject matter of the dependent claims.

The present invention is based on the knowledge that a bifilar winding, applied onto a coil form and consisting of a wire easy to be soldered, fulfils the double function of offering a protection against high currents and breaking the electric circuit in case of an overload current at a high pulse load, at the same time comprising a low inductivity.

Therefore, the solution according to the invention can provide extremely compact and inexpensive protecting devices for electrical appliances which effectively suppress cable-based disorders due to the winding being low in inductance.

According to a preferred embodiment, the present invention includes a protecting device for electrical appliances connected in series with the AC electric circuit of a power supply of the electrical appliance and comprising a bifilar, electrically conductive winding on a coil form, for example of impregnated paper, rubber, glass, ceramics, plastics, ferrite material or a piece of a printed circuit board. The ohmic resistance of the winding restricts the input current and serves for opening the circuit in case of an overload current due to an error in the appliance.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following, and more particular description of the invention as illustrated in the accompanying drawings, wherein:

FIG. 1 shows a block circuit diagram of an AC electric circuit of a power supply with a protecting device according to the prior art,

FIG. 2 shows a schematic representation of a preferred embodiment of the present invention,

FIG. 3 shows a block circuit diagram of an AC electric circuit of a power supply with a protecting device according to a preferred embodiment of the present invention,

FIG. 4a shows a schematic representation of the assembly of the preferred embodiment of the present invention of FIG. 2,

FIG. 4b shows a schematic representation of another assembly possibility of the preferred embodiment of the present invention of FIG. 2,

FIG. 5 shows a schematic representation of a second preferred embodiment of the present invention,

FIG. 6 shows a schematic representation of a third preferred embodiment of the present invention, and

FIG. 7 shows a schematic representation of a fourth preferred embodiment of the present invention.

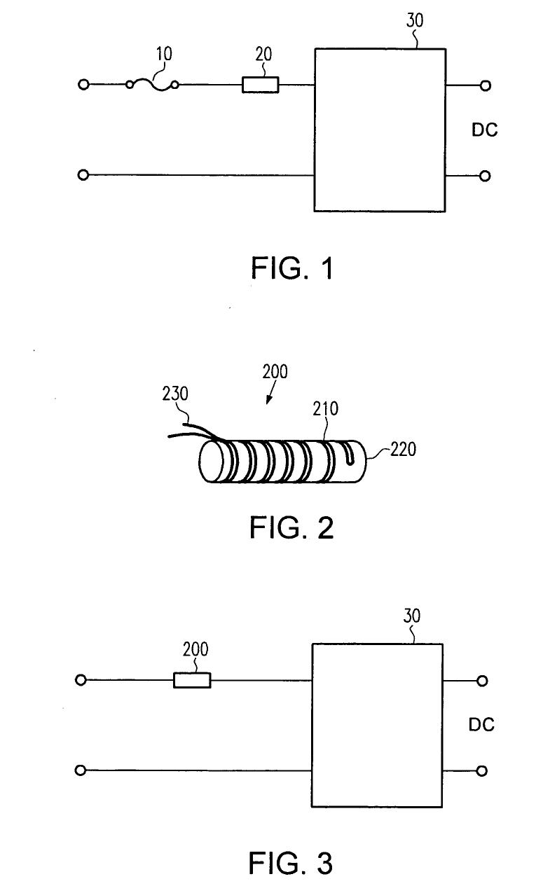

### DETAILED DESCRIPTION OF THE INVENTION

FIG. 2 shows a preferred embodiment 200 of the present invention in a simple schematic representation. A bifilar winding 210 of an electrically conductive material is applied onto a coil form 220 in a number of windings in at least one wound layer. Principally, a bifilar winding is a wire folded to a simple loop and wound about a coil form.

Corresponding to the preferred embodiment, the coil form is cylindrical. The ends 230 of the bifilar winding are attached to one side of the coil form and treated such that they can be installed in a switching circuit of a power supply of an electrical appliance with the usual soldering methods.

In one variant of the preferred embodiment of the present invention, the winding consists of a metal wire which is either coated with an insulating material, so that the windings do not short out, or the wire windings are spaced apart, so that they are not in a conductive contact. If the winding is made of an insulated wire, in a further variant of the preferred embodiment of the present invention, the wire of the bifilar winding can be cabled.

The coil form of the preferred embodiment of the present invention consists of plastics, of ferrite material or of another material of which commercially available printed circuit boards are made.

As already mentioned, the coil form 220 has a cylindrical shape in the preferred embodiment, in variants of the preferred embodiment, it has a cuboid shape.

In a alternative of the preferred embodiment of the present invention, an insulating protective layer is applied over the coil form and the winding. The protective layer or coating of the winding and of the coil form consists of a material which reduces or minimizes flame or smoke formation, preferably of corresponding varnish, foil or flexible insulating tubing materials.

As a material for the bifilar winding, preferably a copper wire is used, which has the advantage that it can be easily soldered. The ends 230 of the winding are preferably pretinplated.

Due to the bifilar winding, induction currents are avoided.

FIG. 3 shows a block circuit diagram of an AC electric circuit of a power supply with a protecting device according to a preferred embodiment of the present invention. The protecting device 200 according to the invention is connected in series with a power pack 30 of an electrical appliance.

According to the preferred embodiment of the present invention, the electrically conductive winding 210 of the protecting device 200 comprises an ohmic wire resistance, increasing the direct impedance of the primary circuit of the power supply and restricting the current at make. This can prevent a damage of other electrical or electronic components connected in series with the AC electric circuit.

As another protecting function, the protecting device according to the invention comprises an opening function of the electric circuit in case of an overload due to an error in the electrical appliance. If the intensity of the input current exceeds a certain value or a certain period, the winding 210 heats due to its ohmic resistance, such that it locally fuses. This opens the electric circuit.

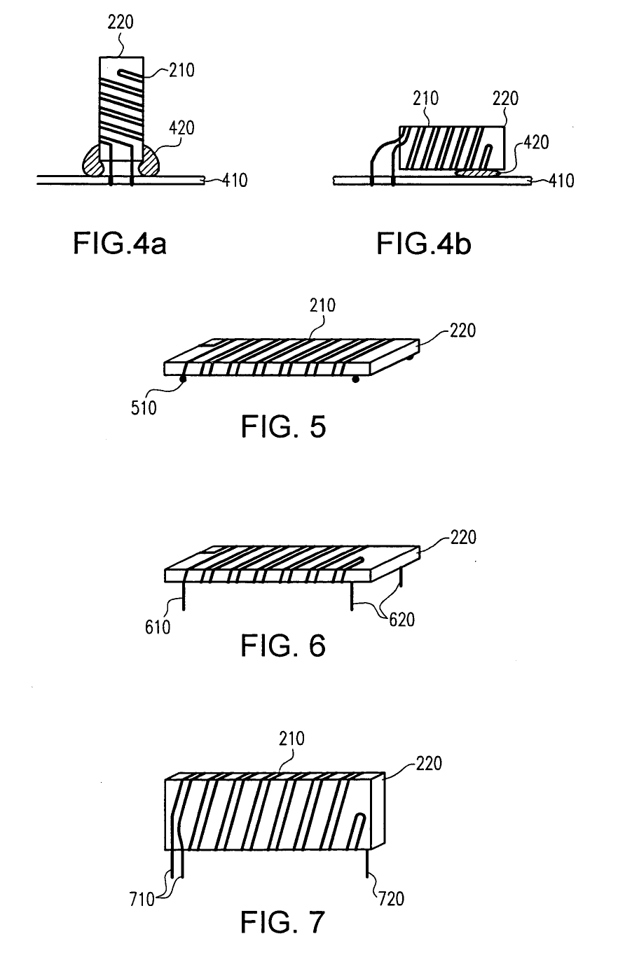

FIG. 4a and FIG. 4b show in a schematic representation the assembly possibilities of preferred embodiments according to FIG. 2 on a printed circuit board 410. In FIG. 4a, the protecting device is soldered into the printed circuit board with the axis of the coil form being perpendicular to the printed circuit board. In this case, the protecting device is brought into contact with the printed circuit board with the wire ends. Commercially available adhesives as well as other fixing means 420 serve for fixing the protecting device on the printed circuit board for mechanically relieving the wire ends 230 and for stably fixing the protecting device.

In a variant of the preferred embodiment, metal pins to which the wire ends of the bifilar winding are conductively fixed are attached to the side of the coil form. In this variant of the preferred embodiment, the protecting device is soldered in the printed circuit board by means of the metal pins. This imparts the necessary mechanical stability to the protecting device and relieves the wire ends of the winding.

In a schematic representation, FIG. 4b shows another variant of the mounting of the preferred embodiment, wherein the axis of the coil form 220 is lying horizontally to the surface of the printed circuit board. In this manner, the overall height of the components applied to the printed circuit board is minimized.

The contacting of the protecting device 200 on a printed circuit board 410 can, for example, be effected by directly soldering in the wire ends 230 or by means of terminal pins.

The horizontal assembly of the protecting device permits a lower overall height with the printed circuit boards for the power supply of an electrical appliance and thus contributes to the miniaturization of the componentry.

According to another embodiment of the present invention, the coil form has a flat cuboid shape. FIG. 5 shows such an embodiment in a schematic representation. Here, the bifilar winding is wound about the cuboid coil form and in a variant of the preferred embodiment, the ends of the bifilar winding are conductively fixed at the short end of the coil form at soldering points. These soldering points are contacted through to so-called solder pads which are preferably located at all four corners of the lower side of the coil form 220. This permits an assembly of the protecting device onto the surface, which makes it possible, to keep the overall height of a component for a power supply low and to enable an inexpensive processing of the electronic components to be installed by the assembly onto the surface.

FIG. 6 shows another preferred embodiment of the present invention in a schematic representation. Here, the flat, cuboid coil form is assembled in the DIL-shape (dual inline). For doing so, it preferably comprises metal pins 610 at all four corners of the lower side of the coil form. The wire ends of the bifilar winding are conductively fixed at two of these pins. This structural shape permits, apart from the soldering in, the protecting device to be inserted into commercially available DIL-bases and be simply exchanged after the winding 210 has fused due to an overload current.

FIG. 7 shows another preferred embodiment of the present invention in a schematic representation. Here, the protecting device is designed in an SIL-shape. This permits a soldering of the protecting device into a printed circuit board as well as the simple, exchangeable assembly of the protecting device into a commercially available SIL-base.

The present invention is not restricted to mentioned preferred embodiments but also extends to the combination of all preferred embodiments.

While the invention has been described with respect to the physical embodiments constructed in accordance therewith, it will be apparent to those skilled in the art that various modifications, variations and improvements of the present invention may be made in the light of the above teachings and within in the purview of the appended claims without departing from the spirit and intended scope of the invention. In addition, those areas in which it is believed that those of ordinary skill in the art of familiar have not been described herein in order not to unnecessarily obscure the invention described herein. Accordingly, it is to be understood that the invention is not to be limited by the specific illustrative embodiments, but only by the scope of the appended claims.

What is claimed is:

1. Protecting device for electrical appliances, connected in series with an AC electric circuit of a power supply of the electrical appliance, having
an electrically conductive winding, said winding comprising an ohmic resistance for restricting input currents, as well as an interruption function, and
a coil form onto which the winding is applied in at least one winding layer,
characterized in that the electrically conductive winding is a bifilar winding.

2. Protecting device according to claim 1, wherein the coil form consists of impregnated paper, rubber, glass, ceramics, plastics, ferrite material or of a piece of printed circuit board.

3. Protecting device according to claim 1, wherein turns of the windings are spaced apart for a mutual insulation.

4. Protecting device according to claim 1, wherein the winding consists of an insulated wire.

5. Protecting device according to claim 1, wherein the winding consists of a copper wire.

6. Protecting device according to claim 1, wherein the protecting device comprises wire ends or terminal pins to be soldered into a printed circuit board.

7. Protecting device according to claim 1, wherein the protecting device comprises soldering points for an assembly on the surface of a printed circuit board.

8. Protecting device according to claim 1, wherein the protecting device comprises a flame retardant coating of a varnish or foil or is covered with a flexible insulating tubing of a flame retardant material.
